(19) United States
(12) Patent Application Publication
(10) Pub. No.: US 2009/0094129 A1
(43) Pub. Date: Apr. 9, 2009

(54) Method of Trading

(76) Inventors: Jeffrey Rhodes, Hertfordshire (GB); Yusuf Nonoo, Manama (BH); Fuad Nonoo, Deira (AE); Kishore Dhakan, Deira (AE)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 11/994,153

(22) PCT Filed: Sep. 22, 2006
(86) PCT No.: PCT/GB2006/003526

§ 371 Date: Jul. 29, 2008

(30) Foreign Application Priority Data
Sep. 29, 2005 (GB) 0519848.6

(51) Int. Cl. G06Q 10/00; G06Q 40/00; G06Q 30/00

(52) U.S. Cl. 705/24; 705/1; 705/35

(57) ABSTRACT

A method of borrowing an item from a lender to a borrower, in which the item has an RFID tracking device affixed thereto. While the item is in the possession of the borrower, the lender uses data transmitted from the RFID tracking device to monitor the item, to be assured of its location and security and optionally to compile an inventory of borrowed items. Whilst the item is in the possession of the borrower, the borrower may pay an interest payment to the lender agreed between the borrower and the lender and derived from the monetary value of the item. The borrower may sell the borrowed item to a third party for a price and pay the lender a sum agreed between the borrower and the lender and derived from a monetary value of the item when it is sold.

### FIELD OF THE INVENTION

The present invention relates to the buying and selling of items in a supply chain.

### BACKGROUND TO THE INVENTION

In a typical supply chain an item is moved from the possession of one party to the next party in the chain, and the ownership of that item is transferred between those parties at the same time. For example, in a retail supply chain a retailer may buy a retail item from a wholesaler or manufacturer and then subsequently sell this item to a customer. However, it can be seen in this scenario that the retailer takes a financial risk when trading in this way as their money will be tied up in the item while it remains unsold, and market price fluctuations may mean that they are not able to sell the item for a price equal to or higher than the price they paid for it.

Recent financing solutions have made it possible for a retailer to pass the financial risk to a third party by introducing a system whereby a retailer may borrow a retail item from a lender and fix the price they pay the lender for that item at the time it is sold to a customer. Thus, the lender may make a profit on the item when the price is paid by the borrower but also accepts the risk that they make a loss if the price paid by the borrower is less than the price the lender paid for that item. In payment for accepting the risk on behalf of the retailer, the lender can seek a fee from the retailer for each item borrowed in addition to the price paid by the retailer for the item. Such a fee is generally in the form of an interest charge based on the value of the item that is payable over the period the retailer is in possession of the borrowed item.

### SUMMARY OF THE INVENTION

Because the risk to the lender in the financing method described above is linked to factors including the credit-worthiness and trust-worthiness of the borrower, and because the cost to the lender of insuring items at a third party site is high, the cost of such lending to the borrower is usually high.

In the present invention an item is borrowed from a lender to be retailed by the borrower. An RFID tracking device is affixed to the item to be borrowed so that the lender may use data transmitted from the device to monitor the item and to be assured of its location and security. The data transmitted by the RFID tracking device may be unique to that item and may be associated with properties of the item such as weight, value, etc. If the borrowed item is sold by the borrower to a third party, the borrower may pay the lender a capital charge for that item derived from the value of that item at the time of sale. Whilst the borrower is in possession of the borrowed item the borrower may pay an interest payment to the lender based on a value of that item.

Thus, according to a first aspect of the present invention there may be provided a method of lending an item, comprising: affixing an RFID tracking device to the item; borrowing the item, the borrowing being from a lender to a borrower; whilst the borrowed item is in the possession of the borrower, periodically obtaining data from the RFID tracking device and sending a confirmation to the lender that the borrowed item is in the possession of the borrower, the confirmation including said data; selling the borrowed item to a third party for a price received by the borrower; and the borrower paying the lender a sum derived from a monetary value of said item when sold to said third party, as agreed between the borrower and the lender.

Also, according to a second aspect of the present invention there may be provided a method of lending an item, comprising: affixing an RFID tracking device to the item; borrowing the item, the borrowing being from a lender to a borrower; whilst the borrowed item is in the possession of the borrower, periodically obtaining data from the RFID tracking device and sending a confirmation to the lender that the borrowed item is in the possession of the borrower, the confirmation including said data; and whilst the borrowed item is in the possession of the borrower, paying an interest payment from the borrower to the lender, the interest payment being derived from a monetary value of said item agreed between the borrower and the lender.

Note that, in the present application, a borrower is someone (a person or organisation) who has possession or control of an item, without being the owner of that item. A lender is then a person or organisation who has ownership (legal title) of the item. When a borrower borrows an item, the item need not be kept in the physical possession of the borrower, but may be, for example, displayed in a shop or other retail premises owned or run by the borrower. When the borrower sells the item to a third party, the third party acquires possession of the item from the borrower, but also ownership of the item from the lender.

Thus, the lender is able accurately to bill the borrower for interest payable on the borrowed item and/or a capital payment based on a value of the borrowed item at the time of sale, and has a high level of assurance that the item is accounted for. The latter can lower the cost of insurance for the lender, which in turn can reduce the cost of the loan to the borrower. In addition, the above method may allow credit-worthiness of the borrower to be removed from the risk profile of the loan so that many small loans may be added together to create a much larger loan that can be managed by a lender in the form of a syndicate of lenders, and so that all borrowers may be offered equal terms of lending.

The RFID tracking device used in the present invention may be any of a variety of commercially available devices. The lender may further increase the level of assurance that the borrowed item is accounted for through the use of a tamper-proof or tamper-resistant RFID tracking device. Such devices are known in the art and disclosed in e.g. WO2005062246.

Preferably, when more than one item is borrowed the borrower will periodically perform an inventory. The inventory may be taken by the remote scanning of all borrowed items affixed with RFID tracking devices contained in the borrower's retail premises so that data transmitted by the devices can be recognized and recorded. Subsequent inventories can be taken to reduce any significant errors (e.g. missed items), and a retail premises may be divided into ‘zones’ by floor area, shelf etc. to ensure that all sections of the premises are sufficiently monitored or to produce a more detailed inventory. This inventory information can be reported to the lender so that they have details of and evidence of the borrowed items in the possession of the borrower.

In a similar way, sales information may be recorded by the borrower through RFID tracking device scanning at the point of sale such that the data transmitted by the RFID tracking device of a sold item may be recognized and reported to the lender. In this way, the lender may have details of and evidence of the borrowed items sold by the borrower.

To further enhance the lender's assurance of the security of the borrowed items, the borrower's inventory and sales recording procedures may be monitored and inspected by the lender to ensure compliance with the agreed processes.

The inventory and sales information reported by the borrower may be used by the lender to procure insurance against loss of the borrowed item, and to claim against this insurance should such a loss occur. This information can be used to further reduce the cost of the insurance to the lender as the risk to the insurer, which may be a sole insurer or a network of insurers, is reduced.

It will be understood that in the method of the present invention a borrowed item is the property of the lender but that an item may be the property of the borrower before the borrowing commences. In such a case the lender will buy the item from the borrower before that item is borrowed.

### BRIEF DESCRIPTION OF THE DRAWINGS

An embodiment of the present invention will now be described, by way of example, with reference to the accompanying drawings, in which:

FIG. 1 is a diagram showing an overview of an item tracking system;

FIGS. 2a and 2b show typical forms of an RFID tracking device;

FIG. 3 is an activity diagram showing the sequence of events when an item is removed from the lender's wholesale premises and taken to the borrower's retail premises;

FIGS. 4a and 4b show overviews of systems for the creation and maintenance of inventories;

FIG. 5 is a diagram showing an overview of a system for recording the sale of an item;

FIG. 6 is an activity diagram showing the sequence of events when an item is sold;

FIG. 7 is a diagram showing an overview of a system for automatically procuring, monitoring and claiming against insurance from a network of insurance providers;

FIG. 8 is a diagram showing an overview of a system for automatically arranging, monitoring and paying for the borrowing of items through a network of lending providers; and

FIG. 9 is an overview diagram showing security cameras integrated into an item tracking system.

### DETAILED DESCRIPTION; FURTHER OPTIONS AND PREFERENCES

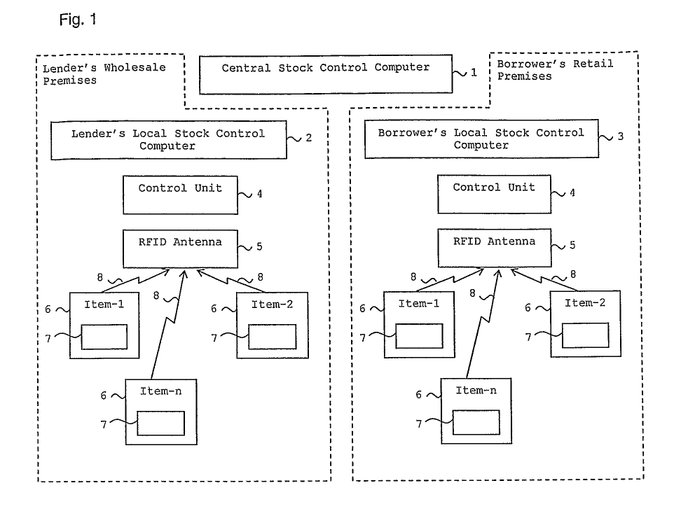

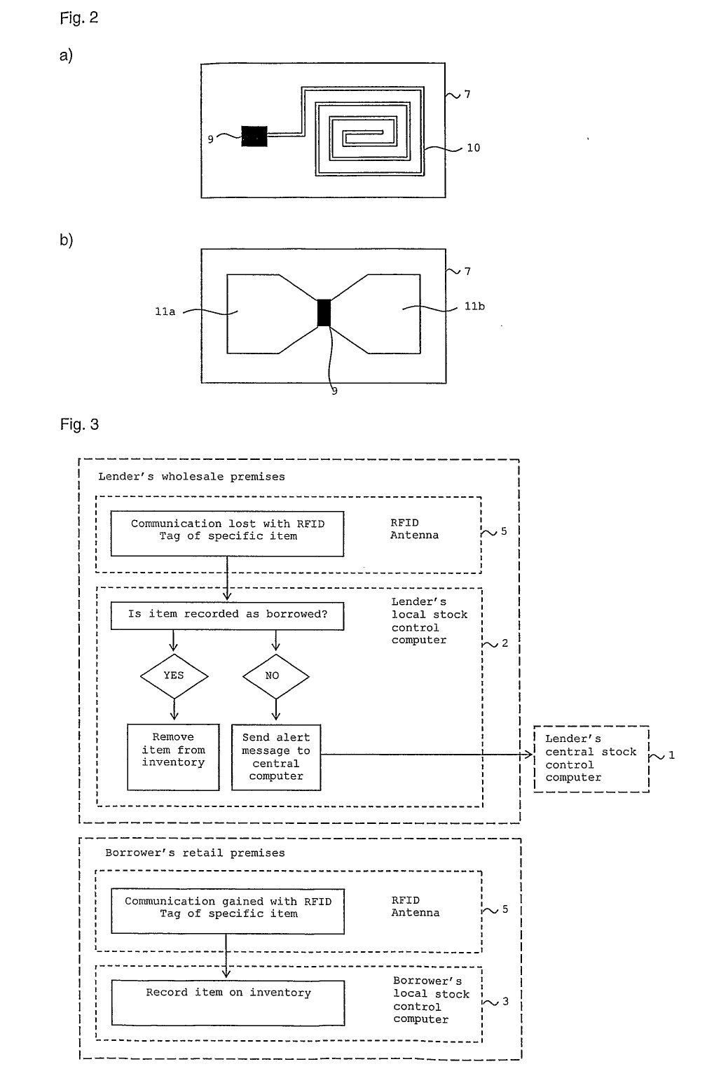

An overview of an item tracking system that can facilitate the use of the method of the present invention will be described herein with reference to FIGS. 1 and 2.

FIG. 1 shows the main components of this item tracking system. A lender's central stock control computer 1 communicates, by cable, via a network, wirelessly, the internet etc., with local stock control computers of the lender's wholesale premises 2 and the borrower's retail premises 3. The lender's local stock control computer 2 communicates, via the control unit 4, with an RFID antenna 5 which detects the presence, or otherwise, of RFID tracking devices 7 affixed to items 6 which together form the stock of the wholesale premises. Data 8 transmitted by the RFID tracking devices 7 contains information about the detected items which is used by the lender's wholesale premises local stock control computer 2 to update and maintain inventory information for the wholesale premises. This inventory information is then communicated to the lender's central stock control computer 1.

The system of the borrower's retail premises is similar in function. The local stock control computer 3 communicates with the RFID antenna 5 of the retail premises, via the control unit 4, to record information about the detected items 6 affixed with RFID tracking devices 7 currently inside the retail premises. This information is used by the local stock control computer 3 to update and maintain inventory information for the retail premises. The inventory information is then communicated to the lender's central stock control computer 1.

Alternatively, the lender's central stock control computer 1 may interrogate the borrower's local stock control computer 3 at any time to verify the location or status of any borrowed item, or such information may periodically be automatically sent by the borrower's local stock control computer 3 to the lender's central stock control computer.

It will be understood that the above system may be adapted to a system of more than one lender's wholesale premises or more than one borrower's retail premises. In addition, it is clear that one wholesale premises or one retail premises may contain more than one RFID antenna for detecting RFID tracking devices, for example where large metallic structures obstruct the progress of a single radio signal to particular areas of a wholesale premises or retail premises, or where it is desirable that a wholesale premises or retail premises be divided into ‘zones’, i.e. by floor area, shelf, building etc.

The RFID tracking device 7 of the above system can be any of a number of commercially available RFID tracking device devices. These devices transmit stored data through radio frequency transmission when the devices are appropriately activated. In addition, RFID tracking devices can receive information and either store or act on that information. An RFID tracking device is composed of an integrated circuit connected to one (or more) antenna(s), which may be in one of two forms, as shown in FIG. 2. FIG. 2a shows an RFID tracking device 7 with an inductive loop antenna 10 connected to an integrated circuit 9, while FIG. 2b shows an RFID tracking device 7 with an antenna comprising two capacitive plates 11a, 11b.

Further developments in the technology of RFID tracking devices means that they may be rendered “tamper-proof” or “tamper-evident” by, for example, being formed with a line of weakness, such as a line of perforations, extending across at least a portion of the antenna or between the antenna and the integrated circuit. When the device is broken along the line of weakness the antenna of the device is rendered unable to communicate with the RFID interrogator device. The RFID interrogator device, such as the RFID antenna 5 of the system described above, can then activate an alarm or send an alert to a central computer, for example, when a device is tampered with.

In a preferred embodiment of the method of the present invention, the borrower selects a number of items 6 (items 1 to n) to borrow from the lender. These items 6 are affixed with RFID tracking devices 7 so that their position may be tracked. The RFID tracking devices may be, for example, in the form of a tag, label, container etc. and may be either fixed directly to the item, to an object fixed to the item, or to a vessel containing the item etc.

The lender may then record in either the central stock control computer 1 or a local wholesale premises stock control computer 2 the details of the items to be borrowed. Such details may include the type of item, the number of items, the weight, the date the borrowing will commence, and an agreed borrowing interest rate, for example.

The items may either be the property of the lender or the property of the borrower before the borrowing commences.

In the former case, when the borrower, or their representative, collects the agreed items from a lender's wholesale premises the method of FIG. 3 is commenced. As the borrowed items are removed from the wholesale premises the RFID antenna 5 loses radio frequency contact with the RFID tracking devices of those items. The RFID antenna 5 passes details of the codes of those RFID tracking devices via the control unit 4 (not shown) to the local stock control computer 2. The local stock control computer checks those codes with it's records: if the item is listed as being borrowed the item is duly removed from the wholesale premises inventory; if, however, the item is not listed as being borrowed, an alert message is sent to the central stock control computer. In addition, in the latter case, an alarm may be sounded or alternative means of registering the unauthorized removal of items may be employed.

When the borrowed items are delivered to the borrower's retail premises the RFID antenna 5 of the retail outlet detects the presence of the RFID tracking devices affixed to the items and passes details of the data transmitted by these RFID tracking devices via the control unit 4 to the local stock control computer 3. The local stock control computer 3 then duly records details of these items on the retail outlet inventory.

Alternatively, when the borrowed property is initially the property of the borrower the lender will purchase the property from the borrower either with cash or by provision of other goods with equivalent value before the borrowing commences. In this case the RFID tracking devices may be affixed to the borrowed items in the borrower's retail outlet or alternative premises of the borrower either before or after the borrowing commences. In the same way as described above, the RFID antenna 5 of the retail outlet detects the presence of the RFID tracking devices affixed to the items and passes details of the data transmitted by these RFID tracking devices via the control unit 4 to the local stock control computer 3. The local stock control computer 3 can then record details of these items on the retail outlet inventory.

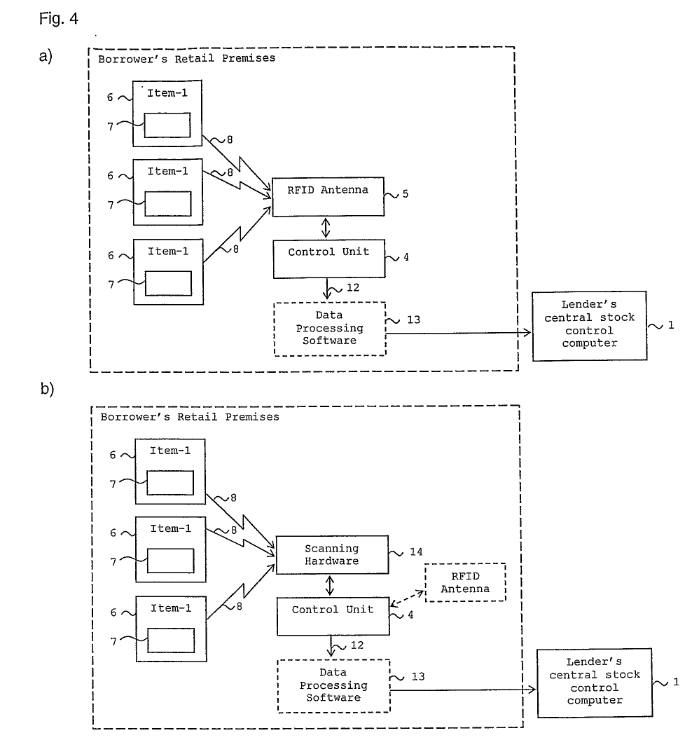

Periodically during the period of the loan the borrower may perform an inventory of the borrowed items. This inventory can be carried out by an automatic method as described below with reference to FIG. 4a. RFID code information 8 transmitted from the RFID tracking devices affixed to the borrowed items 6 present in the borrower's retail premises is received by the RFID antenna 5 and passed to the control unit 4. The control unit 4 passes this stock inventory information to the central stock control computer 1 via an electronic communication channel 12. This communication channel can be via cables, radio frequency, local network, the internet etc. Before the control unit 4 transmits the inventory information to the central stock control computer 1, it may be processed or formatted by data processing software 13.

Alternatively, the inventory may be carried by a manual method by using commonly available scanning hardware 14 to register the presence of an RFID tracking device at close proximity, as shown in FIG. 4b. This scanning hardware may be directly connected to the borrower's local stock control computer 3 so that an inventory list can be compiled locally, and possibly processed or formatted by data processing software 13, before being sent to the central stock control computer 1 via an electronic communication channel 12.

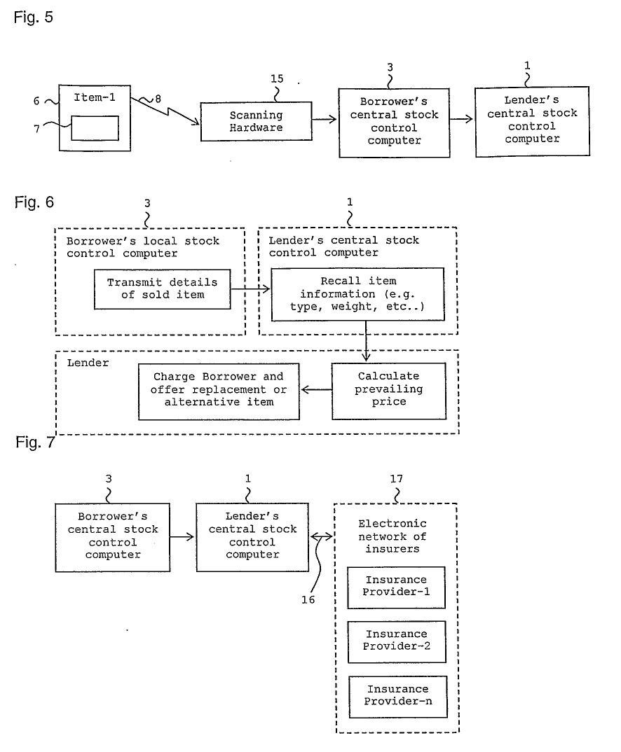

FIGS. 5 and 6 shows the method employed at the point of sale of an item 6 by the borrower. The RFID tracking device 7 of the item is scanned using commonly available scanning hardware 15 which receives and recognises the data transmitted 8 by the RFID tracking device when the RFID tracking device is brought within range. The scanning hardware 15 sends details of the code of the RFID tracking device, via an electronic link, to the borrower's local stock control computer 3. Thus, the local stock control computer 3 determines which item the RFID tracking device 7 is affixed to and removes this item from the inventory.

In addition, the local stock control computer 3 sends details of the sold item to the lender's central stock control computer 1 at the point of sale, as shown in FIG. 6. The lender's central stock control computer 1 passes these details to the lender along with details held about the item such as e.g. weight, type, date borrowing commenced etc.

In a first aspect of the present invention, during the borrowing period the lender may calculate interest payable on each of the borrowed items on a daily basis in order to charge the borrower. The interest rate used for this calculation is that agreed with the borrower and that recorded in the central stock control computer 1. This interest rate may be fixed or may vary. In the case when the borrowed goods are gold jewellery items, the interest rate is preferably charged at an agreed rate above the gold LIBOR interest rate.

In a second aspect of the present invention the lender may use the details of a sold item to determine a cost for that item based on the value of the item at the point of sale, calculated by a method agreed with the borrower, and charge this amount to the borrower. The lender may then offer to supply a replacement item or an alternative item to the borrower. In the case when the borrowed items are gold jewellery items the value of the item will preferably be determined with reference to the London gold fix.

The processes of calculating an interest or cost charge to the borrower, or of offering to supply a replacement or alternative item to the borrower may be automated and communicated to the borrower via electronic communication between the lender's central stock control computer 1 and the borrower's local stock control computer 3.

In order to ensure the risk to the lender is minimized, the lender may purchase insurance against loss of borrowed items held at the borrower's premises through fire, theft, fidelity or terrorism. The inventory and sales information produced by the borrower may be used as evidence of the borrowed items held at the borrower's premises at the time of the loss.

Preferably, the insurance may be purchased, monitored and claimed against through automatic request and reporting by the lender's central stock control computer 1 of the item tracking system to an electronic network of 1 to n insurance providers 16, as shown in FIG. 7. The lender's central stock control computer 1 can send information 16 containing details of the borrowed items currently in the possession of the borrower (sales and inventory information), the prevailing value of the stock, and a status of the stock (stored in wholesale premises, displayed in retail premises, stolen, etc.), for example, to the electronic network of insurers 16. This information can be used by the electronic network of insurers 16 to, for example, determine a cost of insurance, modify a cost of insurance or begin a process of claiming for lost stock against an insurance policy held.

The borrowing of items by a borrower as described above may be made by one lender or by a syndicate of two or more lenders. The lenders may preferably operate in a tiered arrangement of risk-evaluated lending, or lending on a pari passu basis to one or more borrowers. In the case that the lenders operate a tiered arrangement of risk-evaluated lending the interest rate offered to the borrower may be determined according to the level of risk the lenders evaluate for the borrower. In the case that the lenders operate on a pari passu basis all borrowers may be offered an equal interest rate, though this interest rate may vary with the predominant economic conditions.

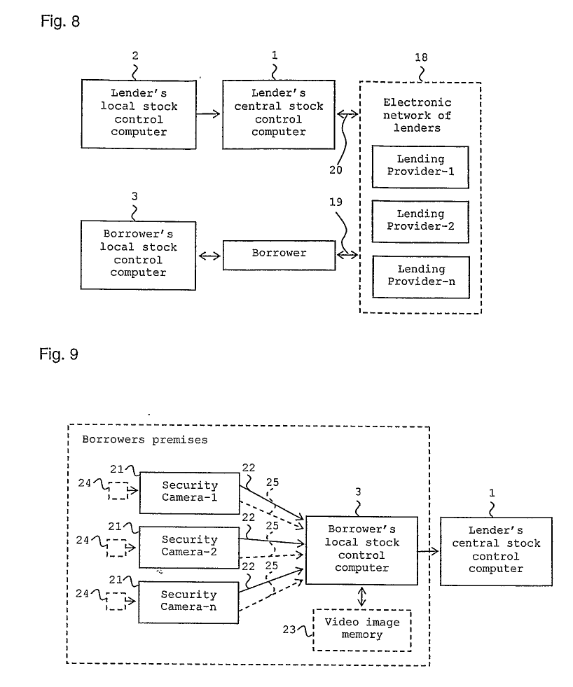

Preferably, the borrowing of items may be arranged, monitored and paid for through automatic request and reporting to an electronic network of lending providers 17, as illustrated in FIG. 8. The borrower can send information to the network of electronic lending providers 17 via an electronic communication channel 16 which may be cabled, wireless, the internet, or a local area network etc. This information can consist of the type of item to be borrowed, whether the borrower wishes to borrow items from the lender's stock or wishes the lender to buy the borrower's stock to be loaned back to him by the lender and the date borrowing should commence, for example. The electronic network of lending providers 17 can then determine an offer or a range of alternative offers for borrowing and can communicate this information to the borrower via the electronic communication channel 16. The borrower can indicate via the electronic communication channel 16 whether the offer is accepted (or which offer is accepted) or rejected. If the offer is accepted, the electronic network of lending providers 17 can confirm the contract with the borrower via the electronic communication channel 16 and can also send details of the contract to the lender's central stock control computer 1. The lender's central stock control computer 1 can then inform the lender's local stock control computer 2 of the agreed items to be borrowed along with information about the borrower and the date for borrowing to commence, etc. and can note these items as ‘borrowed’ in its inventory.

In the method described above, the borrower's local stock control computer may take the form of a Personal Computer connected to the internet or directly to the electronic network of lending providers in the event that the borrower does not already have the system of FIG. 1 installed in their retail premises.

In order to further reduce the level of risk to the lender, security cameras 21 may be integrated in to the item tracking system as shown in FIG. 9. The security cameras 21 may be located in the borrower's premises so as to provide adequate video coverage of the premises. The security cameras can then send analogue or digital video images 22 to the borrower's local stock control computer 3. In the case that the images are analogue they can be converted to a digital format by the borrower's local stock control computer 3, which may store a copy of these digital video images 22 in a video image memory 23, which can be integral with the borrower's local stock control computer 3 or remote from it, before transferring the video digital images 22 to the lender's central stock control computer. The lender can thus have a record of all activity in the borrower's premises which can be utilized in the event that a loss of items is discovered.

Further, the security cameras may be equipped with movement sensor devices 24 so that when movement in the premises is detected out of normal business hours, for example, an alert message 25 may be relayed to the borrower's local stock control computer 3 and/or the lender's central stock control computer 1.

1. A method of borrowing an item (6), comprising:
affixing an RFID tracking device (7) to the item (6);
borrowing the item (6), the borrowing being from a lender to a borrower;
whilst the borrowed item (6) is in the possession of the borrower, periodically obtaining data (8) from the RFID tracking device (7) and sending a confirmation to the lender that the borrowed item (6) is in the possession of the borrower, the confirmation including said data (8);
selling the borrowed item (6) to a third party for a price received by the borrower; and
the borrower paying the lender a sum derived from a monetary value of said item (6) when sold to said third party, as agreed between the borrower and the lender.

2. A method of borrowing an item (6), comprising:
affixing an RFID tracking device (7) to the item (6);
borrowing the item (6), the borrowing being from a lender to a borrower;
whilst the borrowed item (6) is in the possession of the borrower, periodically obtaining data (8) from the RFID tracking device (7) and sending a confirmation to the lender that the borrowed item (6) is in the possession of the borrower, the confirmation including said data (8);
whilst the borrowed item (6) is in the possession of the borrower, paying an interest payment from the borrower to the lender, the interest payment being derived from a monetary value of said item (6) agreed between the borrower and the lender.

3. The method of claims 1 or 2, wherein the borrowing occurs before the affixing of the RFID tracking devices (7);

4. The method of claims 1 or 2, wherein the borrowing occurs after the affixing of the RFID tracking devices (7);

5. The method of any of the preceding claims, wherein the RFID tracking device (7) is a tamper-proof or tamper-resistant RFID tracking device.

6. The method of any of the preceding claims, wherein ownership of the item (6) is transferred from the borrower to the lender before the borrowing of the item.

7. The method of any of the preceding claims, wherein:
a plurality of borrowed items are borrowed;
the data obtained from the RFID tracking devices is used by the borrower to compile an inventory of the borrowed items;
the lender is sent a report of the inventory.

8. The method of any of claims 1 or 3 to 7, wherein:
the selling of a borrowed item (6) is recorded by the borrower through item RFID tracking device (7) scanning at the point of sale; and
the lender is sent a report of the sale.

9. The method of any of the preceding claims, wherein the borrowed item is held in the retail premises of the borrower and security cameras (21) are integrated into RFID scanning equipment therein.

10. The method of any of the preceding claims, wherein:
the lender purchases insurance against the loss of the borrowed item (6) in the possession of the borrower; and
provides the insurer with inventory information and sales information reported by the borrower.

11. The method of any of the preceding claims, wherein the lender is a syndicate of lenders.
